(19) United States
(12) Patent Application Publication
(10) Pub. No.: US 2025/0071824 A1
(43) Pub. Date: Feb. 27, 2025

(54) COMPUTING POWER AWARE RANDOM ACCESS PROCEDURE

(71) Applicant: QUALCOMM Incorporated, San Diego, CA (US)

(72) Inventors: Rui HU, Beijing (CN); Chao WEI, Beijing (CN); Wanshi CHEN, San Diego, CA (US); Peter GAAL, San Diego, CA (US); Hao XU, Beijing (CN); Min HUANG, Beijing (CN); Kangqi LIU, San Diego, CA (US)

(21) Appl. No.: 18/728,423

(22) PCT Filed: Mar. 18, 2022
(86) PCT No.: PCT/CN2022/081629

§ 371 Date: Jul. 11, 2024

(51) Int. Cl. H04W 74/0838; H04L 9/32; H04W 74/00

(52) U.S. Cl. CPC H04W 74/0838; H04L 9/3236; H04W 74/002; H04L 2209/80

(57) ABSTRACT

A method of wireless communication, by a user equipment (UE), includes receiving, from a network device, a trigger command initiating a hash-based random access procedure. The trigger command includes a target hash value and one or more rules for selecting preambles. The method also includes selecting, based on the trigger command, one or more random access channel (RACH) occasions (RO) for potential preamble transmission. The method further includes calculating at least one hash value in response to the trigger command based on computational resources of the UE. The method also includes transmitting a preamble on the at least one selected RO based on the at least one hash value and the target hash value.

### FIELD OF THE DISCLOSURE

The present disclosure relates generally to wireless communications, and more specifically to random access procedures based on computing power of user equipment (UEs).

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP). Narrowband (NB)-Internet of things (IoT) and enhanced machine-type communications (eMTC) are a set of enhancements to LTE for machine type communications.

A wireless communications network may include a number of base stations (BSs) that can support communications for a number of user equipment (UEs). A user equipment (UE) may communicate with a base station (BS) via the downlink and uplink. The downlink (or forward link) refers to the communications link from the BS to the UE, and the uplink (or reverse link) refers to the communications link from the UE to the BS. As will be described in more detail, a BS may be referred to as a Node B, an evolved Node B (eNB), a gNB, an access point (AP), a radio head, a transmit and receive point (TRP), a new radio (NR) BS, a 5G Node B, and/or the like.

The above multiple access technologies have been adopted in various telecommunications standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation.

### SUMMARY

In aspects of the present disclosure, a method of wireless communication, by a user equipment (UE), includes receiving, from a network device, a trigger command initiating a hash-based random access procedure. The trigger command includes a target hash value and one or more rules for selecting preambles. The method also includes selecting, based on the trigger command, at least one random access channel (RACH) occasion (RO) for potential preamble transmission. The method further includes calculating at least one hash value in response to the trigger command based on computational resources of the UE. The method also includes transmitting a preamble on the at least one selected RO based on the at least one hash value and the target hash value.

In other aspects of the present disclosure, a method of wireless communication, by a network device, includes grouping multiple UEs according to computational power. The method also includes providing random access resources to each group such that UEs with more computational power have more opportunities to transmit random access preambles than UEs with less computational power.

In other aspects of the present disclosure, a method of wireless communication, by a network device, includes transmitting a trigger command initiating a hash-based random access procedure. The trigger command includes a target hash value and one or more rules for selecting preambles. The method also includes receiving a preamble on one or more selected ROs based on one or more hash values and the target hash value.

Other aspects of the present disclosure are directed to an apparatus for wireless communication by a user equipment (UE). The apparatus has a memory and one or more processors coupled to the memory. The processor(s) is configured to receive, from a network device, a trigger command initiating a hash-based random access procedure. The trigger command includes a target hash value and one or more rules for selecting preambles. The processor(s) is also configured to select, based on the trigger command, at least one or more random access channel (RACH) occasion (RO) for potential preamble transmission. The processor(s) is further configured to calculate one or more hash value in response to the trigger command based on computational resources of the UE. The processor(s) is also configured to transmit a preamble on the selected RO(s) based on the hash value and the target hash value.

Other aspects of the present disclosure are directed to an apparatus for wireless communication by a network device. The apparatus has a memory and one or more processors coupled to the memory. The processor(s) is configured to transmit a trigger command initiating a hash-based random access procedure. The trigger command includes a target hash value and one or more rules for selecting preambles. The processor(s) is also configured to receive a preamble on at least one selected RO based on at least one hash value and the target hash value.

Aspects generally include a method, apparatus, system, computer program product, non-transitory computer-readable medium, user equipment, base station, wireless communications device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 is a diagram illustrating a common random access channel (RACH) resource pool, in accordance with aspects of the present disclosure.

FIG. 4 is a diagram illustrating a UE timeline and a base station timeline for a first option of a hash-based random access procedure, in accordance with aspects of the present disclosure.

FIG. 5 is timing diagram illustrating the first option for the hash-based random access procedure of FIG. 4, in accordance with aspects of the present disclosure.

FIG. 6 is a block diagram illustrating random access channel (RACH) opportunity (RO) groups, in accordance with aspects of the present disclosure.

FIG. 7 is a diagram illustrating a UE timeline and a base station timeline for a second option of the hash-based random access procedure, in accordance with aspects of the present disclosure.

FIG. 8 is a flow diagram illustrating a process for validating UE reported hash values for the first option of the random access procedure, in accordance with aspects of the present disclosure.

FIG. 9 is a flow diagram illustrating a process for validating UE reported hash values for the second option of the random access procedure, in accordance with aspects of the present disclosure.

FIG. 10 is a flow diagram illustrating an example process performed, for example, by a user equipment (UE), in accordance with various aspects of the present disclosure.

FIG. 11 is a flow diagram illustrating an example process performed, for example, by a network device, in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with 5G and later wireless technologies, aspects of the present disclosure can be applied in other generation-based communications systems, such as and including 3G and/or 4G technologies.

Random access procedures enable a user equipment (UE) to request a connection setup with a network. For example, a UE may initiate a random access procedure when initially establishing a link with the network or when reestablishing a link with the network after radio link failure. Random access procedures may also be used for handover, as well as other scenarios. In some examples, the UE may initiate the random access procedure by transmitting a physical random access channel (PRACH) preamble on a PRACH. The PRACH preamble may be transmitted during a PRACH occasion (also referred to as a random access channel (RACH) occasion (RO)). Random access procedures may be contention-free or contention-based.

A contention-based random access procedure may include four steps: the UE transmits a random access preamble (Msg 1) using resources referred to as a random access channel (RACH) occasion (RO); the network responds with timing information in a random access response (RAR) (Msg 2); the UE transmits a third message (Msg 3) to the network with the UE identity; and the network responds with a fourth message (Msg 4) for contention resolution. For contention-based random access, when there are many more users (N) than resources (K), only K out of N UEs competing for the K resources will achieve maximum resource utilization. Restricting the number of UEs competing for the limited resources reduces collisions between the competing UEs.

According to aspects of the present disclosure, random access may be restricted based on a UE's computing resources. For example, hash operations may be used to control random access. Cryptographic hash algorithms receive an input message and produce a fixed length output. According to aspects of the present disclosure, UEs are divided into different groups based on an actual number of hash operations completed by the UE. Each group may have a same number of dedicated resources for uplink transmission. Hash-based access is thus a non-uniform UE grouping method to prioritize powerful UEs capable of computing more hash operations. Compared to a uniform UE grouping, benefits of hash-based access include improving or reducing collision probability for high-end UEs.

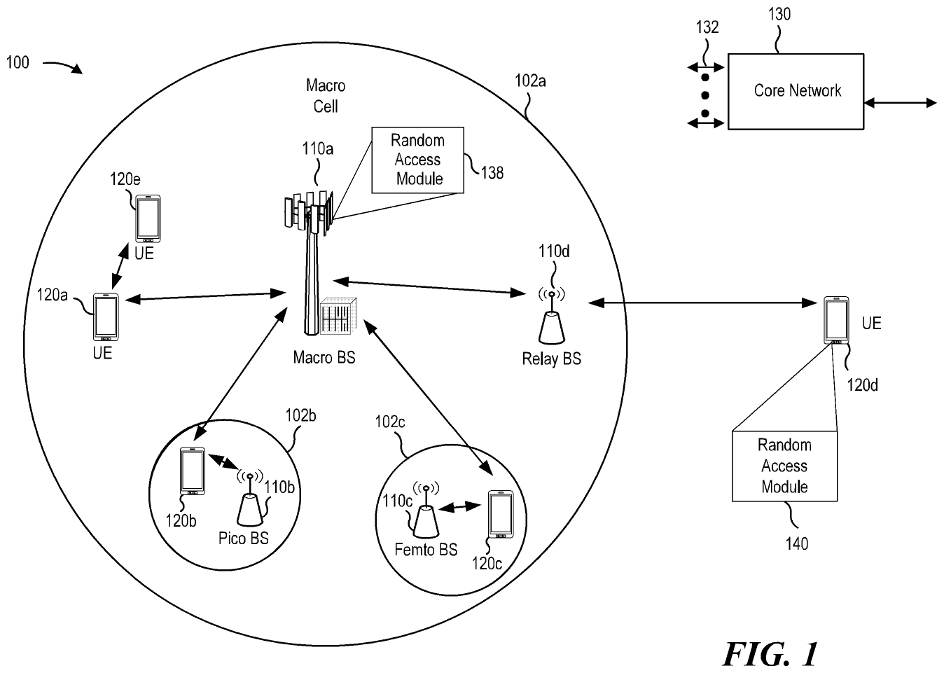

FIG. 1 is a diagram illustrating a network 100 in which aspects of the present disclosure may be practiced. The network 100 may be a 5G or NR network or some other wireless network, such as an LTE network. The wireless network 100 may include a number of BSs 110 (shown as BS 110a, BS 110b, BS 110c, and BS 110d) and other network entities. A BS is an entity that communicates with user equipment (UEs) and may also be referred to as a base station, an NR BS, a Node B, a gNB, a 5G Node B, an access point, a transmit and receive point (TRP), a network node, a network entity, and/or the like. A base station can be implemented as an aggregated base station, as a disaggregated base station, an integrated access and backhaul (IAB) node, a relay node, a sidelink node, etc. The base station can be implemented in an aggregated or monolithic base station architecture, or alternatively, in a disaggregated base station architecture, and may include one or more of a central unit (CU), a distributed unit (DU), a radio unit (RU), a near-real time (near-RT) RAN intelligent controller (RIC), or a non-real time (non-RT) RIC.

Each BS may provide communications coverage for a particular geographic area. In 3GPP, the term “cell” can refer to a coverage area of a BS and/or a BS subsystem serving this coverage area, depending on the context in which the term is used.

A BS may provide communications coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB,” “base station,” “NR BS,” “gNB,” “AP,” “Node B,” “5G NB,” “TRP,” and “cell” may be used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

The wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless network 100 may be a heterogeneous network that includes BSs of different types (e.g., macro BSs, pico BSs, femto BSs, relay BSs, and/or the like). These different types of BSs may have different transmit power levels, different coverage areas, and different impact on interference in the wireless network 100. For example, macro BSs may have a high transmit power level (e.g., 5 to 40 watts) whereas pico BSs, femto BSs, and relay BSs may have lower transmit power levels (e.g., 0.1 to 2 watts).

As an example, the BSs 110 (shown as BS 110a, BS 110b, BS 110c, and BS 110d) and the core network 130 may exchange communications via backhaul links 132 (e.g., S1, etc.). Base stations 110 may communicate with one another over other backhaul links (e.g., X2, etc.) either directly or indirectly (e.g., through core network 130).

The core network 130 may be an evolved packet core (EPC), which may include at least one mobility management entity (MME), at least one serving gateway (S-GW), and at least one packet data network (PDN) gateway (P-GW). The MME may be the control node that processes the signaling between the UEs 120 and the EPC. All user IP packets may be transferred through the S-GW, which itself may be connected to the P-GW. The P-GW may provide IP address allocation as well as other functions. The P-GW may be connected to the network operator's IP services. The operator's IP services may include the Internet, the Intranet, an IP multimedia subsystem (IMS), and a packet-switched (PS) streaming service.

The core network 130 may provide user authentication, access authorization, tracking, IP connectivity, and other access, routing, or mobility functions. One or more of the base stations 110 or access node controllers (ANCs) may interface with the core network 130 through backhaul links 132 (e.g., S1, S2, etc.) and may perform radio configuration and scheduling for communications with the UEs 120. In some configurations, various functions of each access network entity or base station 110 may be distributed across various network devices (e.g., radio heads and access network controllers) or consolidated into a single network device (e.g., a base station 110).

UEs 120 (e.g., 120a, 120b, 120c) may be dispersed throughout the wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communications device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

One or more UEs 120 may establish a protocol data unit (PDU) session for a network slice. In some cases, the UE 120 may select a network slice based on an application or subscription service. By having different network slices serving different applications or subscriptions, the UE 120 may improve its resource utilization in the wireless network 100, while also satisfying performance specifications of individual applications of the UE 120. In some cases, the network slices used by UE 120 may be served by an AMF (not shown in FIG. 1) associated with one or both of the base station 110 or core network 130. In addition, session management of the network slices may be performed by an access and mobility management function (AMF).

The UEs 120 may include a computing power based random access module 140. For brevity, only one UE 120d is shown as including the random access module 140. The random access module 140 may receive, from a network device, a trigger command initiating a hash-based random access procedure. The trigger command includes a target hash value and one or more rules for selecting preambles. The random access module 140 may also select, based on the trigger command, one or more random access channel (RACH) occasions (ROs) for potential preamble transmission. The random access module 140 may further calculate at least one hash value in response to the trigger command based on computational resources of the UE. The random access module 140 may also transmit a preamble on the at least one selected RO based on the at least one hash value and the target hash value.

The core network 130 or the base stations 110 may include a computing power based random access module 138. For brevity, only one base station 110a is shown as including the random access module 138. The random access module 138 may transmit a trigger command initiating a hash-based random access procedure. The trigger command includes a target hash value and one or more rules for selecting preambles. The random access module 138 may also receive a preamble on one or more selected ROs based on one or more hash value and the target hash value.

Some UEs may be considered machine-type communications (MTC) or evolved or enhanced machine-type communications (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communications link. Some UEs may be considered Internet-of-Things (IoT) devices, and/or may be implemented as NB-IoT (narrowband internet of things) devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere as being performed by the base station 110. For example, the base station 110 may configure a UE 120 via downlink control information (DCI), radio resource control (RRC) signaling, a media access control-control element (MAC-CE) or via system information (e.g., a system information block (SIB).

As indicated above, FIG. 1 is provided merely as an example. Other examples may differ from what is described with regard to FIG. 1.

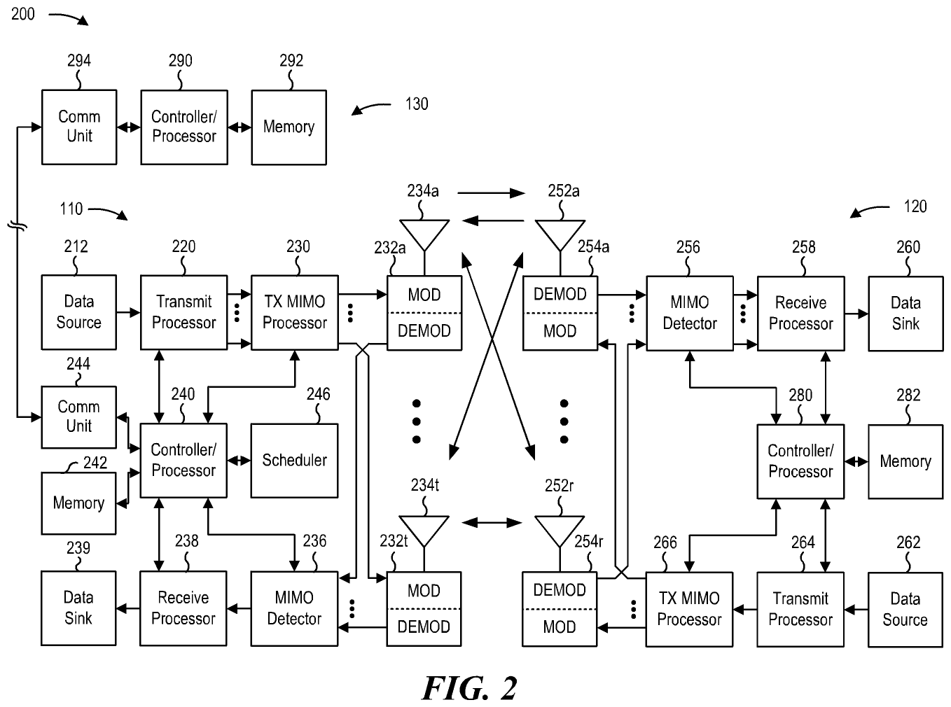

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Decreasing the MCS lowers throughput but increases reliability of the transmission. The transmit processor 220 may also process system information (e.g., for semi-static resource partitioning information (SRPI) and/or the like) and control information (e.g., CQI requests, grants, upper layer signaling, and/or the like) and provide overhead symbols and control symbols. The transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for orthogonal frequency division multiplexing (OFDM) and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for orthogonal frequency division multiplexing (OFDM) and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (e.g., for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (e.g., for DFT-s-OFDM, CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the core network 130 via the communications unit 244. The core network 130 may include a communications unit 294, a controller/processor 290, and a memory 292.

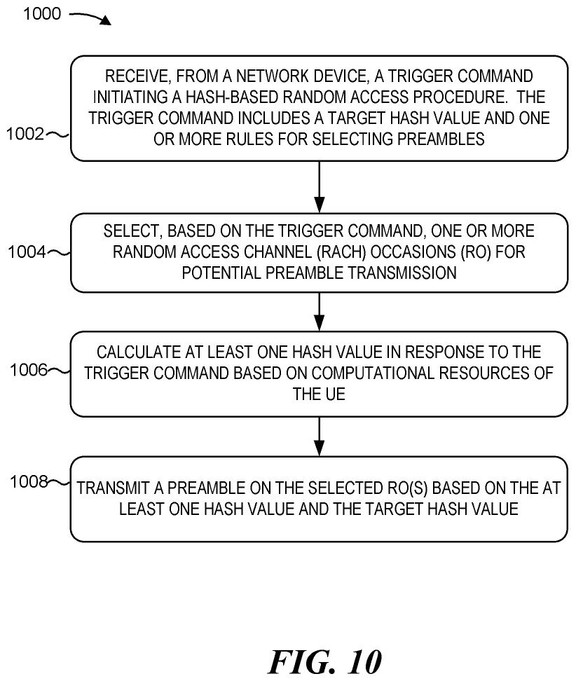

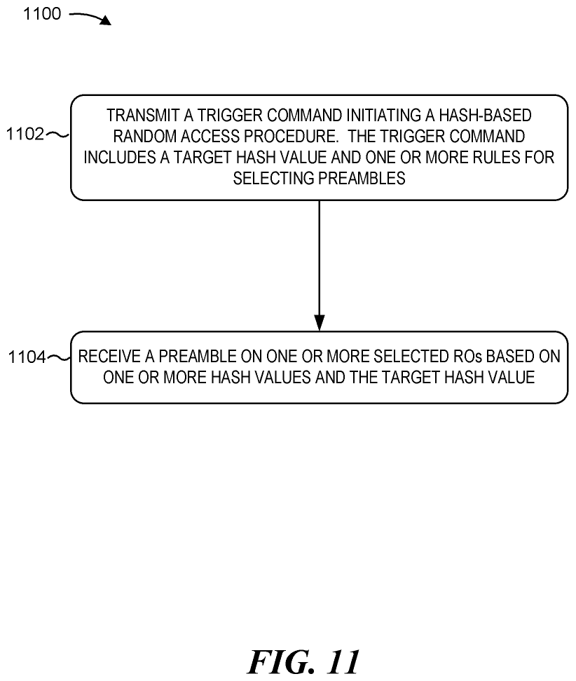

The controller/processor 240 of the base station 110, the controller/processor 280 of the UE 120, and/or any other component(s) of FIG. 2 may perform one or more techniques associated with computing power aware random access procedures, as described in more detail elsewhere. For example, the controller/processor 240 of the base station 110, the controller/processor 280 of the UE 120, and/or any other component(s) of FIG. 2 may perform or direct operations of, for example, the processes of FIGS. 10 and 11 and/or other processes as described. Memories 242 and 282 may store data and program codes for the base station 110 and UE 120, respectively. A scheduler 246 may schedule UEs for data transmission on the downlink and/or uplink.

In some aspects, the UE 120 and/or base station 110 may include means for receiving, means for selecting, means for calculating, means for transmitting, means for determining, means for reporting, means for grouping, means for providing, means for validating. Such means may include one or more components of the UE 120 or base station 110 described in connection with FIG. 2.

As indicated above, FIG. 2 is provided merely as an example. Other examples may differ from what is described with regard to FIG. 2.

Random access procedures enable a UE to request a connection setup with a network. For example, a UE may initiate a random access procedure when initially establishing a link with the network or when reestablishing a link with the network after radio link failure. Random access procedures may also be used for handover, as well as in some other scenarios. Random access procedures may be contention-free or contention-based.

A contention-based random access procedure may include four steps: the UE transmits a random access preamble (Msg 1) using resources referred to as a random access channel (RACH) occasion (RO); the network responds with timing information in a random access response (RAR) (Msg 2); the UE transmits a third message (Msg 3) to the network with the UE identity; and the network responds with a fourth message (Msg 4) for contention resolution. For contention-based random access, when there are many more users (N) than resources (K), only K out of N UEs competing for the K resources will achieve maximum resource utilization. Restricting the number of UEs competing for the limited resources reduces collisions between the competing UEs.

According to aspects of the present disclosure, random access may be restricted based on a UE's computing resources. For example, hash operations may be used to control random access. Cryptographic hash algorithms receive an input message and produce a fixed length output. A property of cryptographic hash algorithms is collision resistance because it is difficult to generate two different inputs resulting in the same hash value. Cryptographic hash algorithms also have a high determinism, where the same input always results in the same output. Cryptographic hash algorithms are irreversible, such that it is difficult to infer the input based on the output.

According to aspects of the present disclosure, UEs are divided into different groups based on an actual number of hash operations completed by the UE. Each group may have a same number of dedicated resources for uplink transmission. Hash-based access is thus a non-uniform UE grouping method to prioritize powerful UEs capable of computing more hash operations. Compared to a uniform UE grouping, benefits of hash-based access include improving or reducing collision probability for high-end UEs.

Current random access procedures do not consider capabilities of different UEs. The current procedures have limited support for differentiation of different random access channel use cases. All UEs have the same access probability no matter the UE type. For example, UEs with enhanced mobile broadband (eMBB) or ultra-reliable low latency communications (URLLC) capability have the same access probability with current random access procedures.

UEs specifying low latency may employ a contention-free random access procedure. Contention-free random access allocates a dedicated signature to the UE on an as-needed basis, such as during handover and when resuming downlink traffic for a UE. However, other use cases may also specify a higher probability of successful access. For example, new uplink data arrival for a URLLC UE may specify a higher likelihood of successful access. Contention-free random access may not be possible if UEs are in a radio resource control (RRC) idle state or an inactive state and the number of UEs accessing a radio cell is large.

One way to improve the likelihood of access is to configure separate RACH resources to different types of UEs. However, this technique may be difficult to implement because the network cannot predict the number of different types of UEs attached to a cell. Further, this technique is unfair to low-end UEs because not all traffic for high-end UEs is time critical. High-end UEs should be able to achieve a higher probability of successful access, but this higher probability should come at some cost to the higher-end UEs.

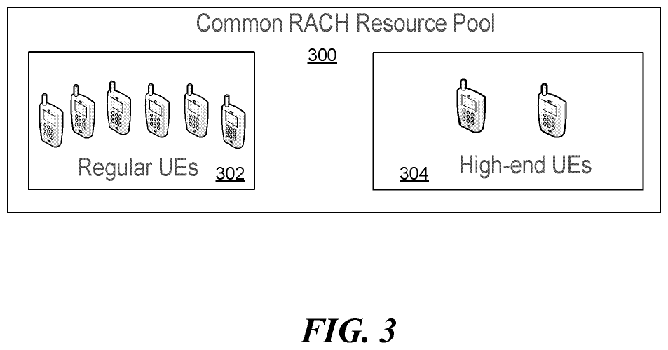

FIG. 3 is a diagram illustrating a common random access channel (RACH) resource pool, in accordance with aspects of the present disclosure. As seen in FIG. 3, a common RACH resource pool 300 may be shared among regular UEs 302 and high-end UEs 304. In order to provide different levels of access to different types of UEs, according to aspects of the present disclosure, different UEs' capabilities may be differentiated via hash operations. High-end UEs are capable of performing more hash operations than regular UEs during the same time period. By associating a UE's RO selection to the number of hash operations completed, high-end UEs performing more hash operations can select ROs that are less competitive. The improved access comes at the cost of more power consumption.

A less competitive RO refers to a RO with fewer UEs competing for the limited resources. Collision probability is therefore reduced. A more successful access probability (or equivalently reduced collision probability) for high capability UEs may be achieved. Moreover, common RACH resources can be shared between high capability and regular UEs, improving overall resource utilization efficiency.

According to aspects of the present disclosure, a network device, such as a base station, broadcasts a target hash and a maximum number Q for hash operations (or Q sets of uplink resources). The larger the number of hash operations completed by the UE (or the higher UE group index), the higher the successful probability for uplink transmission (or lower collision probability).

According to aspects of the present disclosure, a UE is not required to complete computation of all q hash values before the start of the first uplink resource. For subsequent resources (e.g., ROs), a more powerful UE ensures the q^{th} hash values are ready before the q^{th} uplink resources. In some aspects, the base station may confirm the reported hash value on the q^{th} group resource is from the UE performing the q hash operations based on a link between the hash value and the step number or the hash value in the previous q-1 step. The techniques of the present disclosure are compatible with uplink grant-free physical uplink shared channel (PUSCH) transmission and can also be an enhancement for existing random access procedures.

According to aspects of the present disclosure, a base station initiates the hash-based random access with a trigger command transmitted via radio resource control (RRC) signaling and/or downlink control information (DCI). The trigger command may include hash-related parameters and a mapping of ROs and preambles. In some aspects, the hash-related parameters include a target hash h_{target}, and a number of hash operations Qⱼ for the j^{th} RO group, as described in more detail below. The mapping indicates M ROs starting K symbols after the last symbol of the triggering command used for the hash-based access, where K is a minimum processing time for the hash operation. The M ROs (or preambles) may be further divided into Q′ groups, each associated with a number of hash operations. In some aspects, the value of Q′ may be greater than one, and different RO groups may be associated with a different number of hash operations. For example, with two RO groups, one group is associated with Q₁ hash operations and the other group is associated with Q₂ hash operations, such that q₁≠Q₂.

According to aspects of the present disclosure, the base station may trigger a hash-based access command if the base station wants to offer more transmission opportunities for high-end UEs. For example, a base station may want to distinguish high-end UEs for some special use cases, such as online machine learning training. The base station can assign different levels of training tasks based on the different UE computing powers.

According to aspects of the present disclosure, the UE determines one or more ROs for transmission based on the mapping and the calculated hash values. A UE performing more hash operations (and thus using more computational resources) can have opportunities to transmit on more ROs than UEs performing fewer hash operations. Alternatively, the UE may select one RO with a lower collision probability. In other words, a UE that performs more hash operations can transmit on more ROs or less competitive ROs. Therefore, the UE can either choose to spend more transmit power to transmit on more ROs, or choose to spend less transmit power and transmit on the RO that is less competitive and hence increase its successful probability.

In response to a successful RAR, the UE reports a hash value cyclic redundancy check (CRC) in Msg 3 for the base station to validate its hash operation.

As described, a UE performs q≤Q hash operations subject to UE capability and used computing resources. According to aspects of the present disclosure, the UE calculates the q^{th} hash value as h_{q}=Hash(A+B_{q}+C), where Hash( ) is a hash algorithm that both the UE and base station will use, such as SHA-1, SHA-224, etc. The hash algorithm may be standardized or pre-agreed to by the UE and base station. The parameter A is a cell-specific parameter common for all the hash operations, such as the subframe number (SFN) and/or slot index associated with the triggering command. The parameter B_{q} is a parameter that is determined by q, for example, the hash operation index (B_{q}=q), or the time and frequency index (random access radio network temporary identifier (RA-RNTI)) of the q^{th} RO for the hash operation. The parameter C is the UE ID. In some aspects, different types of access with different latency requirements, e.g., eMBB and URLLC, may be differentiated. In these aspects, the traffic type can be an input parameter for the hash operation. In an example implementation, a hash value h_{q} is deemed valid if h_{q}≤h_{target}.

According to aspects of the present disclosure, determination of an RO for preamble transmission may be based on the calculated hash value. Two options are presented for determining whether an RO is available for a UE.

In a first option for determining whether an RO is available for a UE, the UE randomly selects one RO and calculates a hash value using the RA-RNTI. The UE transmits a preamble (e.g., physical random access channel (PRACH)) on the selected RO only if the calculated hash value is valid (e.g., the hash is less than the target (h_{q}≤h_{target})). In some aspects, the UE determines the preamble based on the valid hash value. The same procedure is repeated until no ROs can be selected for transmission, such as when the last RO has already passed. By performing more hash operations, the UE has more PRACH transmission opportunities.

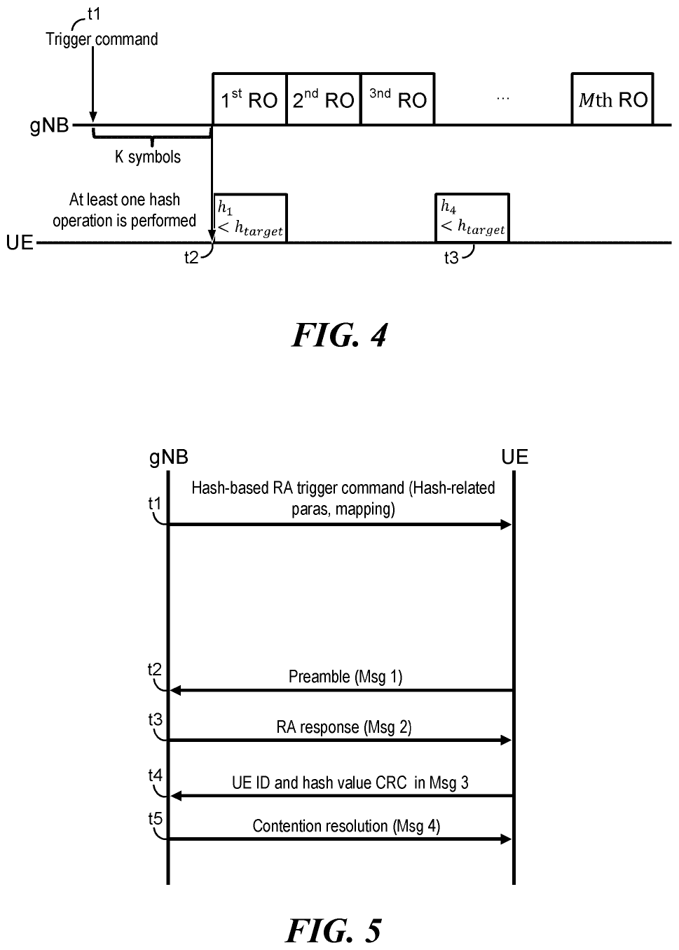

FIG. 4 is a diagram illustrating a UE timeline and a base station timeline for the first option of the hash-based random access procedure, in accordance with aspects of the present disclosure. In the example of FIG. 4, at time t1, a base station (e.g., gNB) transmits a trigger command to a UE. The trigger command includes the target hash h_{target}, and a mapping of ROs and preambles. In response to receiving the trigger command, the UE calculates as many hash operations as desired. The UE may randomly select ROs, calculate hash values, and determine whether to transmit or spend more computing power. For example, the UE may determine whether additional computational resources should be used to increase the likelihood of successful access. Because the UE needs to select a RO (e.g., time-frequency resource) to transmit the PRACH, before transmitting the PRACH, the UE may randomly select one RO from the available ROs. The UE then uses the RA-RNTI associated with the selected RO to calculate the hash value and determine whether the UE can transmit on this selected RO.

In the example of FIG. 4, the first RO occurs K symbols after time t1, that is, at time t2. If the UE was able to calculate a hash value that was less than the target hash h_{target}, then the UE may transmit a preamble (physical random access channel (PRACH)) during the first RO. In the example of FIG. 4, the UE successfully computed a hash value (h₁) that is less than the hash target h_{target}, allowing the UE to transmit in the first RO.

In some aspects, the calculated hash value h_{q} may be used to select a preamble index. For example, the preamble index may be determined in accordance with a preamble mapping indicated by the trigger command. In one example implementation, the mapping may be h_{q} mod Nₚ, where Nₚ is the total number of preambles. By selecting the preamble index in this manner, the base station can validate the hash value h_{q} before PRACH transmission because the UE reports the hash value h_{q} to the base station later in the process during Msg 3. More specifically, the UE obtains a valid hash value prior to PRACH transmission. Therefore, the calculation of the hash value happens before PRACH transmission. When the base station receives the UE's preamble, the PRACH transmission already happened, and the base station should be able to validate whether this UE has calculated and obtained a valid hash value. Because the UE reports its calculated hash value in a later stage (e.g., Msg 3), upon receiving the UE's preamble, the base station cannot directly validate whether this UE has performed the hash operation. In order to enable the base station to determine whether the UE obeys the rules, the mapping of preamble index and hash value can help the base station to determine whether a UE performed a hash operation before PRACH transmission. This mechanism prevents selfish UEs from transmitting the PRACH without performing hash operations.

The UE continues to perform hash operations in accordance with the determined level of access desired. In the example of FIG. 4, the UE successfully completed another hash operation for the fourth RO. That is, the fourth hash value h₄ is less than the target hash value h_{target}. As a result, the UE is also able to transmit a preamble in the fourth RO at time t3.

FIG. 5 is a timing diagram illustrating the first option for the hash-based random access procedure of FIG. 4, in accordance with aspects of the present disclosure. In the example of FIG. 5, a base station (e.g., gNB) communicates with a UE. At time t1, the base station transmits a random access (RA) trigger command to the UE. The hash-based RA trigger command includes hash related parameters, such as the target hash h_{target}, and a mapping of ROs and preambles.

When an RO is available for the UE based on a valid hash value, the UE transmits a PRACH preamble at time t2, in message 1 (Msg 1). In the first option, the UE randomly selects an RO and the UE uses the random access radio network temporary identifier (RA-RNTI) to calculate the hash value for each selected RO. The UE transmits the PRACH preamble on the ROs corresponding to valid hash values. In the example of FIG. 4, the UE transmits on the first and fourth ROs. As shown in FIG. 5, at time t3, the base station responds with a random access (RA) response (Msg 2).

At time t4, the UE transmits a message 3 (Msg 3). According to aspects of the present disclosure, the UE may use Msg 3 to report its UE ID and calculated hash values for validation. To reduce overhead, according to aspects of the present disclosure, the UE may also report an n-bit cyclic redundancy check (CRC) for the hash value h_{q}, instead of the actual calculated hash value.

At time t5, the base station transmits a contention resolution message (Msg 4) to complete the random access procedure. If the base station determines any of the reproduced hash values are not valid or the n-bit CRC does not match, the base station may determine the UE is a rogue UE and terminate the RACH procedure by skipping Msg 4 transmission. In other aspects, the base station transmits a media access control-control element (MAC-CE) to terminate the RACH process.

In a second option for determining whether an RO is available for a UE, a number, M, of ROs are divided into Q′ groups. The UE selects one RO group and one RO from the selected RO group for PRACH transmission. For a PRACH transmission on the RO in the q^{th} (q>1) RO group, a condition should be met. The condition is that a UE should have performed at least Q=Σⱼ₋₁^{q′-1}Qⱼ hash operations and all the hash values (h₁, h₂, . . . ,h_{Qj}, . . . , h_{Q}) are valid, where Qⱼ is the number of hash operations a UE is specified to perform for the j^{th} RO group. The value Qⱼ may be pre-configured when configuring the mapping of ROs to hash operations. In some aspects, the first RO group may be used for PRACH transmission by any UE that is unable to acquire all the valid hash values specified for the first RO group to ensure access is available to all UEs.

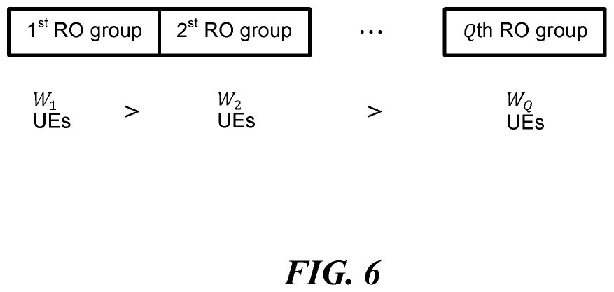

For the q^{th} RO group, there will be W_{q′} UEs attempting transmission where W_{q′}<W_{q′-1}. For example, there will be fewer UEs for RO group four than for RO group three. Hence, the collision probability is lower for the larger indexed RO group. FIG. 6 is a block diagram illustrating random access channel (RACH) opportunity (RO) groups, in accordance with aspects of the present disclosure. According to this property, as seen in FIG. 6, a number, W₁, of UEs attempting transmission in the first RO group is larger than a number, W₂, of UEs attempting transmission in the second RO group, which is larger than a number, W_{Q}, of UEs attempting transmission in the Q^{th} RO group.

Similar to the first option, the calculated hash value h_{q} can also be used to select the preamble index for the second option. The index of the RO within the RO group may also be based on the calculated hash value h_{q} for the second option. For example, the RO index may be given by hₗₐₛₜ mod M_{q′} and the preamble index may be given by floor(hₗₐₛₜ/M_{q′}) mod Nₚ, where Nₚ is the total number of preambles, M_{q′} is the number of ROs in the q^{th} RO group, and hₗₐₛₜ is the last calculated hash value. The formula for selecting the preamble index allows the base station to validate whether the hash value hₗₐₛₜ is calculated before PRACH transmission because the UE later reports hₗₐₛₜ in Msg 3.

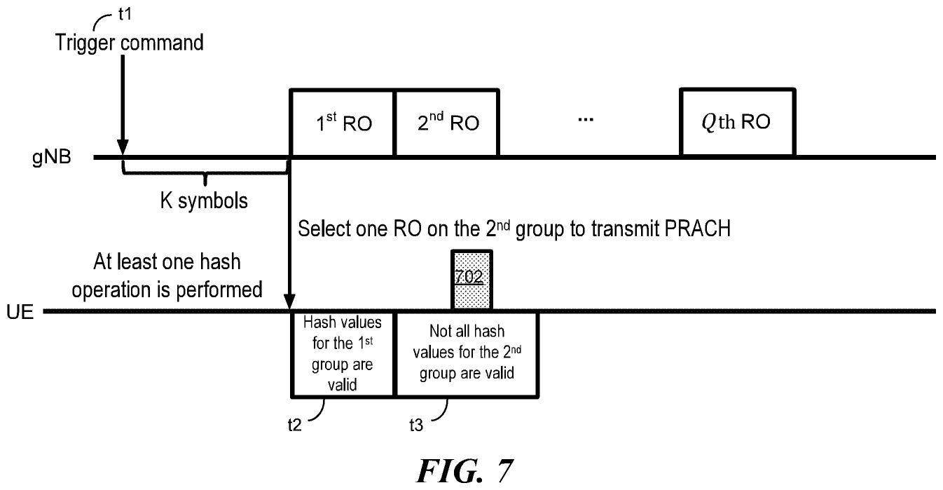

FIG. 7 is a diagram illustrating a UE timeline and a base station timeline for the second option of the hash-based random access procedure, in accordance with aspects of the present disclosure. In the example of FIG. 7, at time t1, a base station (e.g., gNB) transmits a trigger command to a UE. The trigger command includes the target hash h_{target}, a mapping of ROs and preambles, and a number of hash operations Qⱼ for the j^{th} RO group. In response to receiving the trigger command, the UE calculates Qⱼ hash operations for each RO group. The UE may determine whether additional computational resources should be used to increase the likelihood of successful access when deciding how many hash values to compute. In the example of FIG. 7, the UE calculates Q₁ hash values for the first RO group and unsuccessfully attempts to calculate Q₂ hash values for the second RO group.

The first RO occurs K symbols after time t1, that is, at time t2. If the UE is able to calculate all previous Σⱼ₋₁^{q′-1}Qⱼ hash values, the UE may transmit a preamble (e.g., PRACH) on one RO in the q^{th} RO group. That is, the UE obtain all valid hash values for q-1 groups to enable transmission on the q-th group. In the example of FIG. 7, the UE successfully obtains Q₁ valid hash values for the first group, enabling access to one RO in the second group. The UE then transmits on the selected RO group 702. Note that for the UE to transmit on the second group, the UE can have invalid hash values for the second group. In other words, there are no restrictions on the hash values for the second group.

In some aspects, the preamble index and RO index are based on the last calculated hash value. For example, the preamble index may be determined as hₗₐₛₜ mod M_{q′}. The UE continues to perform hash operations for each RO group. In the example of FIG. 7, the UE did not compute valid hash values for the second RO group. As a result, the UE is able to transmit a preamble in the second RO group at time t3.

As described above, the UE reports its calculated hash values in Msg 3 to enable a base station to determine whether a UE has a valid hash value (as in the first option) or performed q hash operations and received all the valid hash values (as in the second option). According to aspects of the present disclosure, to reduce overhead, the UE reports an n-bit cyclic redundancy check (CRC) for h_{q} for the first option and for (h₁, h₂, . . . ,h_{q}) for the second option, instead of the calculated hash values. Based on the reported UE ID, for example, as indicated in Msg 3, and the configured hash parameters, the base station reproduces the hash values for a cyclic redundancy check. If any of the reproduced hash values are invalid or the n-bit CRC does not match, the base station may determine the UE is a rogue UE and terminate the RACH process in Msg 4. For example, the base station may skip Msg 4 transmission or may terminate the process via a dedicated MAC-CE.

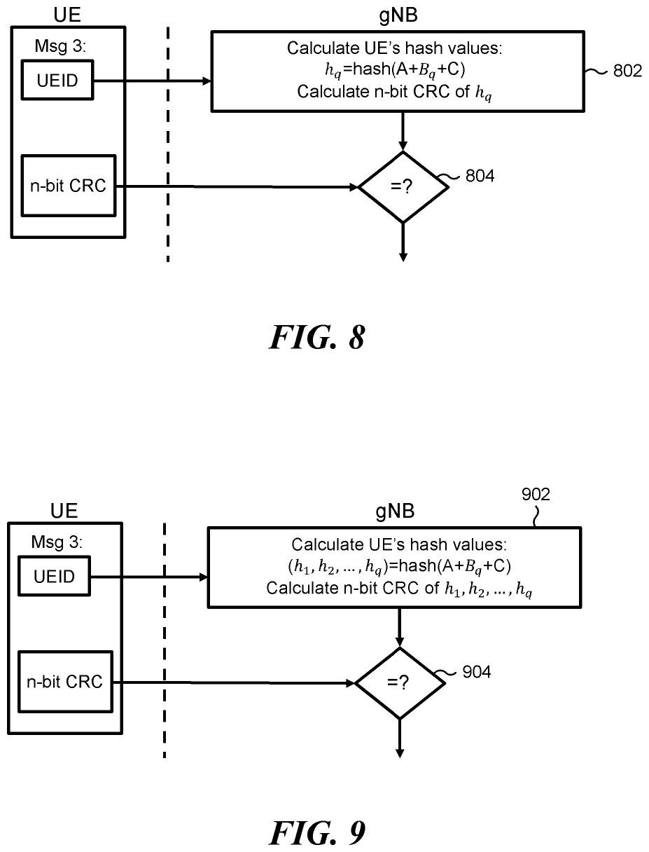

FIG. 8 is a flow diagram illustrating a process for validating UE reported hash values for the first option of the random access procedure, in accordance with aspects of the present disclosure. In the example of FIG. 8, a UE transmits a Msg 3 to a base station (e.g., gNB). The Msg 3 includes a UE ID and an n-bit CRC formulated from the valid hash value computed by the UE. At block 802, the base station calculates the UE's hash values for the UE selected RO, for example, in accordance with the formula h_{q}=Hash(A+B_{q}+C). The base station also calculates the n-bit CRC of the hash value h_{q}. At block 804, the base station compares the n-bit CRC calculated at block 802 with the n-bit CRC received from the UE in Msg 3. If there is a match, the RACH process continues with the base station transmitting Msg 4. If there is no match, the base station terminates the RACH process.

FIG. 9 is a flow diagram illustrating a process for validating UE reported hash values for the second option of the random access procedure, in accordance with aspects of the present disclosure. In the example of FIG. 9, a UE transmits a Msg 3 to a base station (e.g., gNB). The Msg 3 includes a UE ID and an n-bit CRC based on the valid hash values computed by the UE. At block 902, the base station calculates the UE's hash values on its own, for example, in accordance with the formula (h₁, h₂, . . . h_{q}) =Hash(A+B_{q}+C). The base station also calculates the n-bit CRC of the hash values (h₁, h₂, . . . h_{q}), for example, by concatenating the hash values and calculating a CRC based on the concatenation. At block 904, the base station compares the n-bit CRC calculated at block 902 with the n-bit CRC received from the UE in Msg 3. If there is a match, the RACH process continues with the base station transmitting Msg 4. If there is no match, the base station terminates the RACH process.

As indicated above, FIGS. 3-9 are provided as examples. Other examples may differ from what is described with respect to FIGS. 3-9.

FIG. 10 is a flow diagram illustrating an example process 1000 performed, for example, by a user equipment (UE), in accordance with various aspects of the present disclosure. The example process 1000 is an example of a random access procedure based on computing power of user equipment (UEs). The operations of the process 1000 may be implemented by a UE 120.

At block 1002, the user equipment (UE) receives, from a network device, a trigger command initiating a hash-based random access procedure. The trigger command includes a target hash value and one or more rules for selecting preambles. For example, the UE (e.g., using the antenna 252, DEMOD/MOD 254, MIMO detector 256, receive processor 258, controller/processor 280, and/or memory 282) may receive the trigger command. In some aspects, the rules may indicate a mapping of ROs and preambles. In other aspects, the rules also indicate a number of hash operations Qⱼ for the j^{th} RO group.

At block 1004, the user equipment (UE) selects, based on the trigger command, one or more random access channel (RACH) occasions (RO) for potential preamble transmission. For example, the UE (e.g., using the controller/processor 280, and/or memory 282) may select the RO. In some aspects, the UE selects the RO(s) by selecting an RO group when the UE has obtained all hash values for a previous RO group. The selected RO(s) is within the selected RO group. In other aspects, the selected RO(s) is a valid hash value that satisfies a condition associated with the target hash value.

At block 1006, the user equipment (UE) calculates at least one hash value in response to the trigger command based on computational resources of the UE. For example, the UE (e.g., using the controller/processor 280, and/or memory 282) may calculate the hash value. In some aspects, more computational resources of the UE enable computing of more hash functions increasing successful access probability.

At block 1008, the user equipment (UE) transmits a preamble on the at least one selected RO based on the at least one hash value and the target hash value. For example, the UE (e.g., using the antenna 252, DEMOD/MOD 254, TX MIMO processor 266, transmit processor 264, controller/processor 280, and/or memory 282) may transmit the preamble. In some aspects, the UE transmits on the selected RO(s) in response to the at least one hash value corresponding to the selected RO(s) being a valid hash value satisfying a condition associated with the target hash value. In other aspects, the UE transmits on the selected RO(s) in response to calculating at least a threshold number of valid hash values.

FIG. 11 is a flow diagram illustrating an example process 1100 performed, for example, by a network device, in accordance with various aspects of the present disclosure. The example process 1100 is an example of a random access procedure based on computing power of user equipment (UEs). The operations of the process 1100 may be implemented by a network device, such as the base station 110.

At block 1102, the network device transmits a trigger command initiating a hash-based random access procedure. The trigger command includes a target hash value and one or more rules for selecting preambles. For example, the base station (e.g., using the antenna 234, MOD/DEMOD 232, TX MIMO processor 230, transmit processor 220, controller/processor 240, and/or memory 242) may transmit the trigger command. In some aspects, the rules may indicate a mapping of ROs and preambles. In other aspects, the rules also indicate a number of hash operations Qⱼ for the j^{th} RO group.

At block 1104, the network device receives a preamble on one or more selected ROs based on one or more hash value and the target hash value. For example, the base station (e.g., using the antenna 234, MOD/DEMOD 232, MIMO detector 236, receive processor 238, controller/processor 240, and/or memory 242) may receive the preamble. In some aspects, the network device validates whether a user equipment (UE) has performed a number of valid hash operations based on a cyclic redundancy check (CRC) value associated with a threshold number of valid hash values received from the UE. In other aspects, the UE validates the at least one hash value based on a mapping between a preamble index and the at least one hash value.

### Example Aspects

Aspect 1: A method of wireless communication, by a user equipment (UE), comprising: receiving, from a network device, a trigger command initiating a hash-based random access procedure, the trigger command including a target hash value and at least one rule for selecting preambles; selecting, based on the trigger command, at least one random access channel (RACH) occasion (RO) for potential preamble transmission; calculating at least one hash value in response to the trigger command based on computational resources of the UE; and transmitting a preamble on the at least one selected RO based on the at least one hash value and the target hash value.

Aspect 2: The method of Aspect 1, in which the at least one hash value is based on an identifier of the at least one selected RO; and the method further comprises transmitting on the at least one selected RO in response to the at least one hash value corresponding to the at least one selected RO being a valid hash value satisfying a condition associated with the target hash value.

Aspect 3: The method of Aspect 1 or 2, further comprising determining a preamble index based on the valid hash value and a total number of preambles.

Aspect 4: The method of any of the preceding Aspects, further comprising reporting a plurality of cyclic redundancy check (CRC) bits associated with the valid hash value.

Aspect 5: The method of Aspect 1, in which selecting the at least one RO comprises selecting an RO group when the UE has obtained all hash values for a previous RO group, the at least one selected RO being within the selected RO group; and the method further comprises transmitting on the at least one selected RO in response to calculating at least a threshold number of valid hash values.

Aspect 6: The method of any of preceding Aspects 1 or 5, further comprising selecting the RO group in response to a number of valid hash values not satisfying a minimum threshold value.

Aspect 7: The method of any of preceding Aspects 1, 5, or 6, further comprising: determining a preamble index based on a last calculated hash value, a total number of preambles and a total number of ROs in the selected RO group; and determining an RO index based on the last calculated hash value and the number of ROs within the RO group.

Aspect 8: The method of any of the preceding Aspects, further comprising reporting a plurality of cyclic redundancy check (CRC) bits associated with a threshold number of valid hash values.

Aspect 9: The method of any of the preceding Aspects, further comprising receiving a media access control-control element (MAC-CE) terminating the hash-based random access procedure in response to any hash value reported to the network device being determined to be invalid.

Aspect 10: The method of any of the preceding Aspects, in which more computational resources of the UE enable computing of more hash functions increasing successful access probability.

Aspect 11: A method of wireless communication, by a network device, comprising: grouping a plurality of UEs according to computational power; and providing random access resources to each group such that UEs with more computational power have more opportunities to transmit random access preambles than UEs with less computational power.

Aspect 12: A method of wireless communication, by a network device, comprising: transmitting a trigger command initiating a hash-based random access procedure, the trigger command including a target hash value and at least one rule for selecting preambles; and receiving a preamble on at least one selected RO based on at least one hash value and the target hash value.

Aspect 13: The method of Aspect 12, further comprising validating the at least one hash value based on a cyclic redundancy check (CRC) value received from a user equipment (UE).

Aspect 14: The method of Aspect 12, further comprising validating whether a user equipment (UE) has performed a number of valid hash operations based on a cyclic redundancy check (CRC) value associated with a threshold number of valid hash values received from the UE.

Aspect 15: The method of Aspect 12 or 14, further comprising validating the at least one hash value based on a mapping between a preamble index and the at least one hash value.

Aspect 16: The method of any of the Aspects 12-15, further comprising transmitting a media access control-control element (MAC-CE) terminating hash-based random access in response to any hash value reported to the network device being determined to be invalid.

Aspect 17: An apparatus for wireless communication, by a user equipment (UE), comprising: a memory; and at least one processor coupled to the memory, the at least one processor configured: to receive, from a network device, a trigger command initiating a hash-based random access procedure, the trigger command including a target hash value and at least one rule for selecting preambles; to select, based on the trigger command, at least one random access channel (RACH) occasion (RO) for potential preamble transmission; to calculate at least one hash value in response to the trigger command based on computational resources of the UE; and to transmit a preamble on the at least one selected RO based on the at least one hash value and the target hash value.

Aspect 18: The apparatus of Aspect 17, in which the at least one hash value is based on an identifier of the at least one selected RO; and the at least one processor is further configured to transmit on the at least one selected RO in response to the at least one hash value corresponding to the at least one selected RO being a valid hash value satisfying a condition associated with the target hash value.

Aspect 19: The apparatus of Aspect 17 or 18, in which the at least one processor is further configured to determine a preamble index based on the valid hash value and a total number of preambles.

Aspect 20: The apparatus of any of the Aspects 17-19, in which the at least one processor is further configured to report a plurality of cyclic redundancy check (CRC) bits associated with the valid hash value.

Aspect 21: The apparatus of Aspect 17, in which the at least one processor selects the at least one RO by selecting an RO group when the UE has obtained all hash values for a previous RO group, the at least one selected RO being within the selected RO group; and the at least one processor is further configured to transmit on the at least one selected RO in response to calculating at least a threshold number of valid hash values.

Aspect 22: The apparatus of any of the Aspects 17 or 21, in which the at least one processor is further configured to select the RO group in response to a number of valid hash values not satisfying a minimum threshold value.

Aspect 23: The apparatus of any of the Aspects 17, 21 or 22, in which the at least one processor is further configured: to determine a preamble index based on a last calculated hash value, a total number of preambles and a total number of ROs in the selected RO group; and to determine an RO index based on the last calculated hash value and the number of ROs within the RO group.

Aspect 24: The apparatus of any of the Aspects 17-23, in which the at least one processor is further configured to report a plurality of cyclic redundancy check (CRC) bits associated with a threshold number of valid hash values.

Aspect 25: The apparatus of any of the Aspects 17-24, in which the at least one processor is further configured to receive a media access control-control element (MAC-CE) terminating the hash-based random access procedure in response to any hash value reported to the network device being determined to be invalid.

Aspect 26: The apparatus of any of the Aspects 17-25, in which more computational resources of the UE enable computing of more hash functions increasing successful access probability.

Aspect 27: An apparatus for wireless communication, by a network device, comprising: a memory; and at least one processor coupled to the memory, the at least one processor configured: to transmit a trigger command initiating a hash-based random access procedure, the trigger command including a target hash value and at least one rule for selecting preambles; and to receive a preamble on at least one selected RO based on at least one hash value and the target hash value.

Aspect 28: The apparatus of Aspect 27, in which the at least one processor is further configured to validate the at least one hash value based on a cyclic redundancy check (CRC) value received from a user equipment (UE).

Aspect 29: The apparatus of Aspect 27 or 28, in which the at least one processor is further configured to validate whether a user equipment (UE) has performed a number of valid hash operations based on a cyclic redundancy check (CRC) value associated with a threshold number of valid hash values received from the UE.

Aspect 30: The apparatus of any of the Aspects 27-29, in which the at least one processor is further configured to validate the at least one hash value based on a mapping between a preamble index and the at least one hash value.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed is:

1. A method of wireless communication, by a user equipment (UE), comprising:
receiving, from a network device, a trigger command initiating a hash-based random access procedure, the trigger command including a target hash value and at least one rule for selecting preambles;
selecting, based on the trigger command, at least one random access channel (RACH) occasion (RO) for potential preamble transmission;
calculating at least one hash value in response to the trigger command based on computational resources of the UE; and
transmitting a preamble on the at least one selected RO based on the at least one hash value and the target hash value.

2. The method of claim 1, in which the at least one hash value is based on an identifier of the at least one selected RO; and the method further comprises transmitting on the at least one selected RO in response to the at least one hash value corresponding to the at least one selected RO being a valid hash value satisfying a condition associated with the target hash value.

3. The method of claim 2, further comprising determining a preamble index based on the valid hash value and a total number of preambles.

4. The method of claim 2, further comprising reporting a plurality of cyclic redundancy check (CRC) bits associated with the valid hash value.

5. The method of claim 1, in which selecting the at least one RO comprises selecting an RO group when the UE has obtained all hash values for a previous RO group, the at least one selected RO being within the selected RO group; and the method further comprises transmitting on the at least one selected RO in response to calculating at least a threshold number of valid hash values.

6. The method of claim 5, further comprising selecting the RO group in response to a number of valid hash values not satisfying a minimum threshold value.

7. The method of claim 5, further comprising:
determining a preamble index based on a last calculated hash value, a total number of preambles and a total number of ROs in the selected RO group; and
determining an RO index based on the last calculated hash value and the number of ROs within the RO group.

8. The method of claim 1, further comprising reporting a plurality of cyclic redundancy check (CRC) bits associated with a threshold number of valid hash values.

9. The method of claim 1, further comprising receiving a media access control-control element (MAC-CE) terminating the hash-based random access procedure in response to any hash value reported to the network device being determined to be invalid.

10. The method of claim 1, in which more computational resources of the UE enable computing of more hash functions increasing successful access probability.

11. A method of wireless communication, by a network device, comprising:
grouping a plurality of UEs according to computational power; and
providing random access resources to each group such that UEs with more computational power have more opportunities to transmit random access preambles than UEs with less computational power.

12. A method of wireless communication, by a network device, comprising:
transmitting a trigger command initiating a hash-based random access procedure, the trigger command including a target hash value and at least one rule for selecting preambles; and
receiving a preamble on at least one selected RO based on at least one hash value and the target hash value.

13. The method of claim 12, further comprising validating the at least one hash value based on a cyclic redundancy check (CRC) value received from a user equipment (UE).

14. The method of claim 12, further comprising validating whether a user equipment (UE) has performed a number of valid hash operations based on a cyclic redundancy check (CRC) value associated with a threshold number of valid hash values received from the UE.

15. The method of claim 12, further comprising validating the at least one hash value based on a mapping between a preamble index and the at least one hash value.

16. The method of claim 12, further comprising transmitting a media access control-control element (MAC-CE) terminating hash-based random access in response to any hash value reported to the network device being determined to be invalid.

17. An apparatus for wireless communication, by a user equipment (UE), comprising:
a memory; and
at least one processor coupled to the memory, the at least one processor configured:
to receive, from a network device, a trigger command initiating a hash-based random access procedure, the trigger command including a target hash value and at least one rule for selecting preambles;
to select, based on the trigger command, at least one random access channel (RACH) occasion (RO) for potential preamble transmission;
to calculate at least one hash value in response to the trigger command based on computational resources of the UE; and
to transmit a preamble on the at least one selected RO based on the at least one hash value and the target hash value.

18. The apparatus of claim 17, in which the at least one hash value is based on an identifier of the at least one selected RO; and the at least one processor is further configured to transmit on the at least one selected RO in response to the at least one hash value corresponding to the at least one selected RO being a valid hash value satisfying a condition associated with the target hash value.

19. The apparatus of claim 18, in which the at least one processor is further configured to determine a preamble index based on the valid hash value and a total number of preambles.

20. The apparatus of claim 18, in which the at least one processor is further configured to report a plurality of cyclic redundancy check (CRC) bits associated with the valid hash value.

21. The apparatus of claim 17, in which the at least one processor selects the at least one RO by selecting an RO group when the UE has obtained all hash values for a previous RO group, the at least one selected RO being within the selected RO group; and the at least one processor is further configured to transmit on the at least one selected RO in response to calculating at least a threshold number of valid hash values.

22. The apparatus of claim 21, in which the at least one processor is further configured to select the RO group in response to a number of valid hash values not satisfying a minimum threshold value.

23. The apparatus of claim 21, in which the at least one processor is further configured:
to determine a preamble index based on a last calculated hash value, a total number of preambles and a total number of ROs in the selected RO group; and
to determine an RO index based on the last calculated hash value and the number of ROs within the RO group.

24. The apparatus of claim 17, in which the at least one processor is further configured to report a plurality of cyclic redundancy check (CRC) bits associated with a threshold number of valid hash values.

25. The apparatus of claim 17, in which the at least one processor is further configured to receive a media access control-control element (MAC-CE) terminating the hash-based random access procedure in response to any hash value reported to the network device being determined to be invalid.

26. The apparatus of claim 17, in which more computational resources of the UE enable computing of more hash functions increasing successful access probability.

27. An apparatus for wireless communication, by a network device, comprising:
a memory; and
at least one processor coupled to the memory, the at least one processor configured:
to transmit a trigger command initiating a hash-based random access procedure, the trigger command including a target hash value and at least one rule for selecting preambles; and
to receive a preamble on at least one selected RO based on at least one hash value and the target hash value.

28. The apparatus of claim 27, in which the at least one processor is further configured to validate the at least one hash value based on a cyclic redundancy check (CRC) value received from a user equipment (UE).

29. The apparatus of claim 27, in which the at least one processor is further configured to validate whether a user equipment (UE) has performed a number of valid hash operations based on a cyclic redundancy check (CRC) value associated with a threshold number of valid hash values received from the UE.

30. The apparatus of claim 27, in which the at least one processor is further configured to validate the at least one hash value based on a mapping between a preamble index and the at least one hash value.
